(19) United States
(12) Patent Application Publication
(10) Pub. No.: US 2011/0183590 A1
(43) Pub. Date: Jul. 28, 2011

(54) FILLING APPARATUS, MACHINE AND METHOD FOR FILLING OF CASINGS, PARTICULARLY SAUSAGE CASINGS

(75) Inventor: Klaus Hiller, Dorverden (DE)

(73) Assignee: VEMAG MASCHINENBAU GMBH, Verden/Aller (DE)

(21) Appl. No.: 12/307,454

(22) PCT Filed: Jul. 9, 2007
(86) PCT No.: PCT/EP07/56976

§ 371 Date: May 24, 2010

(30) Foreign Application Priority Data
Jul. 7, 2006 (DE) 20 2006 010 597.2

(51) Int. Cl. A22C 11/02

(52) U.S. Cl. 452/45; 452/30

(57) ABSTRACT

The invention concerns a method of and a filling apparatus for a machine for filling casings, in particular sausage cases, comprising a filling tube (14) which is drivable and rotatable about its longitudinal axis (12) and on to which can be pulled a case (8) which can be filled by the filling tube (14), and a case brake (26) which is arranged at the open end (22) of the filling tube (14) in a holding frame (24) and which has a brake ring (28) which is mounted rotatably coaxially with respect to the axis of rotation of the filling tube (14) by means of a mounting means (34) and a bearing (32). According to the invention the open end (22) of the filling tube (14) is so designed as to co-operate with the brake ring (28) and the case (8) in such a way that the brake ring (28) is drivable by means of the filling tube (14) in frictional and/or positively locking relationship and a torque can be transmitted to the case (8).

The present invention concerns a filling apparatus for a machine for filling casings, in particular sausage cases, comprising a filling tube which is drivable and rotatable about its longitudinal axis and on to which can be pulled a case which can be filled by the filling tube, and a case brake which is arranged at the open end of the filling tube in a carrier frame.

The invention further concerns a machine for filling casings such as sausage cases comprising a supply container for pasty materials, in particular sausage meat, a conveyor device connected to the supply container for conveying sausage meat and a filling apparatus having a filling tube which is rotatable and drivable about its longitudinal axis and on to which can be pulled a case which can be filled by the filling tube and a case brake arranged at the open end of the filling tube.

The invention additionally concerns a method of filling casings, in particular sausage cases, in which a case is pulled on to a filling tube and filled by means of a pasty material, in particular sausage meat, flowing out of the filling tube, and is withdrawn from the filling tube by the pressure of the material, and wherein a twist-off location is produced for portioning of the case by rotation of the filling tube, wherein the case co-operates with a rotatable brake ring of a case brake.

Filling apparatuses, filling machines and filling methods for casings of that kind are known. Filling apparatuses are a component part of a filling machine, by means of which pasty materials, in particular sausage meat, can be introduced into casings such as case skins of plastic material or natural sausage skin and the casings can be twisted off in such a way that separable filled portions of a length and a weight which as far as possible are equal are produced, which can be separated from each other to produce individual sausages.

Prior to filling the case it is pulled on to the filling tube. The case can be of different diameters, also referred to as calibers. By means of a conveyor device such as for example a pump, in particular a conveyor curve arrangement or a vane impeller device, the sausage meat is pressed through the filling tube into the case which is pulled off at one end. When an adjustable amount of sausage meat has been introduced into the case the filling tube which is mounted rotatably about its longitudinal axis is rotated by means of a drive to twist off the case, which provides that the case which has been pulled on to the filling tube is also rotated therewith. In that way the case is twisted off at a twist-off or constriction location. After the case has been twisted off, the rotation of the filling tube is stopped and a selectable amount of sausage meat is again pressed through the filling tube into the case and at the same time the case is pulled off the tube. The twist-off operation is then started afresh. In that way individual, portioned sausages can be produced.

In a filling apparatus known from EP 1 048 213 the case is caused to rotate together with the filling tube by means of a case entrainment device which engages into the filling tube in substantially positively locking relationship. The case is twisted off by the case being held fast by a non-rotating case brake arranged in front of the open end of the filling tube. To be able to guarantee reliable entrainment of the case in the rotational movement with the filling tube over its entire length the case entrainment device is displaceable along the filling tube. To be able to permit such displaceability a longitudinal groove is provided along the filling tube, into which groove the case entrainment device can engage. A disadvantage in that respect is that a case is not always completely twisted off at the beginning and the end of the respective case, because of slippage, and that is disadvantageous in economic terms and therefore undesirable.

Other known solutions have at the open end of the filling tube a driven brake ring which is integrated into a case brake and which presses the case against the filling tube. To ensure that the case rotates at approximately the same speed as the filling tube known solutions provide that the brake ring is caused to rotate by way of a separate drive unit. Besides the structural complication and expenditure, such solutions suffer from the disadvantage that the components required for that purpose are subjected to a great deal of wear as very high cycle frequencies are required in usual sausage production procedures, that is to say both the filling tube and also the brake ring are accelerated and decelerated again within a very short time (in the millisecond range). As a consequence of those procedures the components in question such as bearings and gears have to be frequently replaced, which is not only highly cost-intensive but also time-intensive as production has to be interrupted for that purpose. The cycle frequency is detrimentally affected by virtue of an increased mass inertia of the components of the separate drive unit, that are to be accelerated and decelerated.

The object of the present invention is to avoid the disadvantages of the state of the art and to provide a filling apparatus, a filling machine and a method of filling casings, in particular sausage cases, which in a structurally simple fashion ensure that the sausage portions are reliably twisted off, in particular even at high cycle frequencies.

In a filling apparatus, a machine and a method of filling casings of the kind set forth in the opening part of this specification, that object is attained in that the open end of the filling tube is so designed as to co-operate with the brake ring and the case in such a way that the brake ring is drivable by means of the filling tube in frictional and/or positively locking relationship and a torque can be transmitted to the case.

The configuration according to the invention of the filling tube provides that the case reliably rotates with the filling tube, at the open end of the filling tube. The sausage portions, in particular the first and the last portions, are guaranteed to be twisted off, without the brake ring having to be driven by way of a separate drive unit with the aforementioned disadvantages. As the configuration according to the invention of the filling tube and the brake ring means that it is possible to dispense with the separate drive unit, the number of components which have to be replaced on account of wear is reduced. Accordingly, stoppage times because of replacement operations and stockkeeping of corresponding components can be reduced and the machine or the method of filling casings can be more economically operated.

A further improvement in the transmission of torque from the filling tube to the case and the brake ring, in substantially frictional and/or positively locking relationship, is achieved if the peripheral surface of the open end of the filling tube has a smooth or roughened surface or has elongate recesses of V-shaped or curved cross-section. Those surfaces or recesses are to be provided on the part of the peripheral surface of the filling tube, that is in contact with the brake ring. The configuration of the open end of the filling tube preferably does not lead to the peripheral surface of the filling tube including apertures.

A preferred embodiment of the invention is distinguished in that the brake ring is freely rotatably supported and not driven by a separate drive unit. It is preferably made from elastic light material and supported in easy-running bearings such as rolling bearings, in particular easy-running ball bearings. In that way the moment of resistance to be overcome upon acceleration is minimised and the generation of slip is substantially avoided.

In accordance with a further preferred embodiment the brake ring has a through opening for passing the case therethrough, the opening being of a round or polygonal cross-section and/or at its inner peripheral surface having one or more recesses of any cross-section. That increases the friction between the brake ring, the case and the filling tube and improves the transmission of torque with a constant contact pressure of the brake ring against the filling tube. Axial displaceability of the case during the filling operation is retained in that way and the probability of damaging the case during the filling operation is low.

In the machine according to the invention for filling casings, in particular sausage cases, which is designed in accordance with the above-described embodiments, it is possible to achieve substantially the same advantages as with the above-discussed filling apparatus. The same also applies to the method according to the invention of filling casings, in particular sausage cases. Advantageous embodiments are set forth in the appendant claims and will be apparent from the description hereinafter of preferred embodiments by way of example, which are described in greater detail with reference to the Figures.

In the drawings:

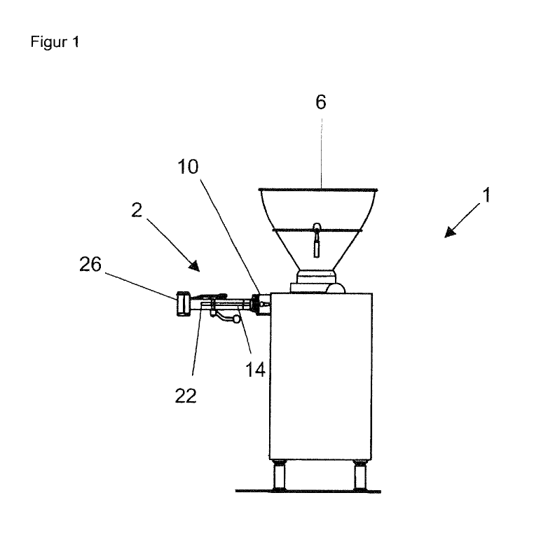

FIG. 1 shows a side view of a machine for filling casings with a filling apparatus according to the invention,

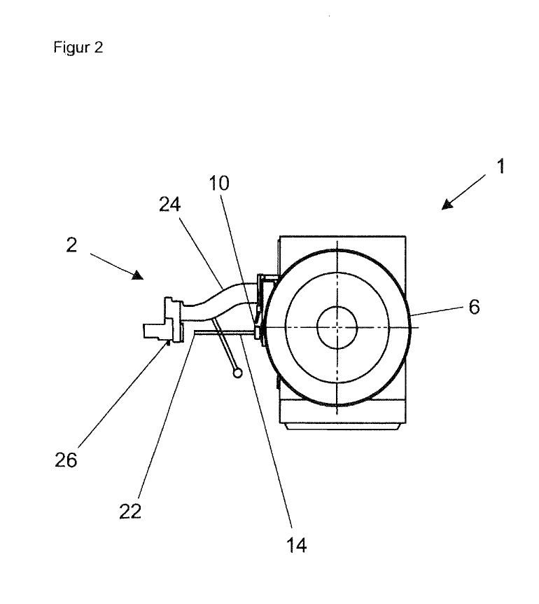

FIG. 2 shows a plan view of a machine for filling casings with a filling apparatus according to the invention,

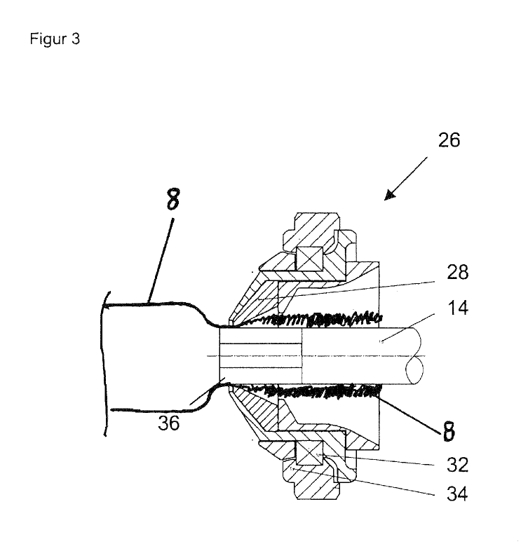

FIG. 3 shows a sectional view of the case brake and the filling tube,

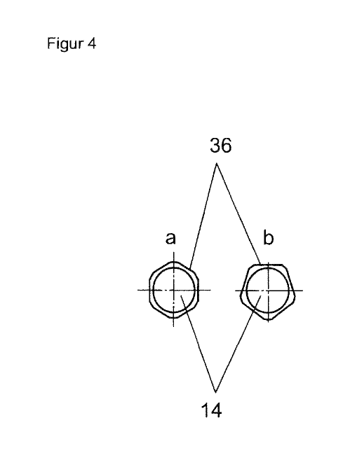

FIG. 4 shows sectional views of possible embodiments of the open end of the filling tube, and

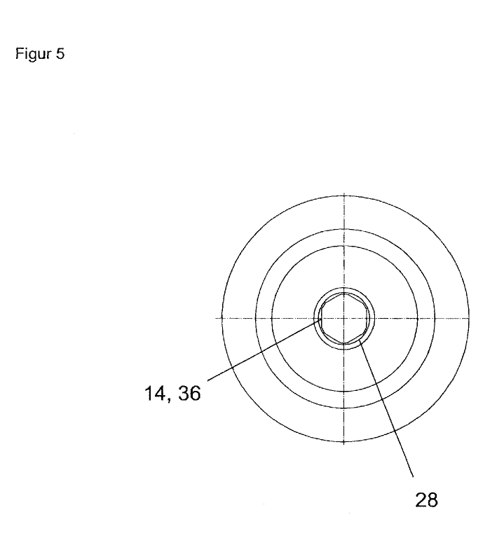

FIG. 5 shows a further sectional view of the interchangeable part and the filling tube.

FIG. 1 shows a machine 1 for filling casings, in particular sausage cases, which is equipped with a filling apparatus 2 according to the invention. The machine 1 further includes a supply container in the form of a filling hopper 6, a conveyor device (not shown) for conveying pasty materials, in particular sausage meat, drives, control and regulating units and operating devices for operating the machine 1. The sausage meat deposited in the supply container 6 is fed by means of the conveyor device to the filling apparatus 2, by means of which the casing (not shown) to be filled can be filled with sausage meat or other pasty materials.

The casing to be filled, in particular a sausage skin or case 8, is pulled on to a hollow filling tube 14 (FIG. 3) which is caused to rotate by a drive transmission 10. It is also possible to see a case brake 26 having a brake ring 28 (FIG. 3) mounted rotatably in coaxial relationship with the axis of rotation of the filling tube 14. The co-operation of the brake ring 28, the case 8 and the filling tube 14 provides that the brake ring 28 is drivable by means of the filling tube and a torque is transmitted at an open end 22 (FIG. 2) of the filling tube 14 to the case 8 and the filled case 8 is twisted off by the filling tube 14 and individual portioned sausages are produced in that fashion.

FIG. 2 shows a plan view of the machine 1, illustrating the filling tube 14 with the open end 22. The Figure also shows a holding frame 24 for the mounting for the case brake 26. Sausage meat or other pasty material can flow by means of the conveyor device through the filling tube 14 and is pressed through the open end 22 of the filling tube 14 into the case (not shown) to be filled. The holding frame 24 is supported rotatably so that for example when a new case 8 is being pulled on to the filling tube 14 the case brake 26 can be quickly and easily separated from the filling tube 14 and then connected to the filling tube 14 again.

The case brake 26 shown in detail in FIG. 3 has a brake ring 28 mounted rotatably in a mounting means 34 with a bearing 32 which is in the form of a rolling bearing, in particular a ball bearing. In addition configurational features 36 are indicated in the peripheral surface in the region of the open end 22 of the filling tube 14 (see also FIG. 5). It will be seen that the configurational features 36 have to be provided only of such a length that the brake ring 28 can be reliably in engagement with them and with the case 8. The brake ring 28 is preferably made from light elastic material and the mounting means 34 from strong high-quality steel. The light structure of the brake ring 28 together with its mounting arrangement involving easy-running rolling bearings, in particular ball bearings, provides that it can be easily set in rotation and there is no need to overcome a high level of resistance. The tendency to slippage is minimised thereby.

FIG. 4 shows some embodiments by way of example of the configurational feature 36 of the filling tube 14. In FIG. 4a the peripheral surface has six flat faces in the manner of a hexagon, wherein the intermediate regions between the flat faces, as illustrated, can be in the form of flat faces or alternatively can also be rounded. In FIG. 4b the arrangement has five flat faces. In both FIG. 4a and also FIG. 4b the faces are of such a dimension that they do not immediately adjoin each other but a part of the round peripheral surface of the filling tube remains between them. The examples illustrated here only represent some possible implementations of the configurational features 36 and do not have any limiting effects on the claimed scope of protection.

FIG. 5 shows an embodiment illustrating how the brake ring 28 can co-operate with the open end 22 of the filling tube 14 so that the brake ring 28 is drivable by means of the filling tube. The configurational features 36 are in the form of six flat faces in FIG. 5. The brake ring 28 has a round opening for the filling tube.

FIGS. 1 through 5 show that the configuration selected in accordance with the invention for the brake ring 28 and the open end 22 of the filling tube 14 affords a possible way of driving the brake ring 28 by means of the filling tube 14 and with the interposition of the case 8, without the need for a separate drive unit for the brake ring 28. The structural complication and expenditure is markedly reduced by the configuration according to the invention of the open end 22 of the filling tube 14 and the brake ring 28, in comparison with constructions in which the brake ring 28 is driven by way of a separate drive unit. The number of components required is minimised by the elimination of the drive unit for the brake ring 28. As an immediate consequence, the number of components affected by wear is also reduced and accordingly fewer parts also have to be replaced. The number of spare parts to be stocked as well as the stoppage times, caused by replacement, of the machine designed according to the invention and the method operated in accordance with the invention are markedly reduced.

1. A filling apparatus for a machine for filling casings, in particular sausage cases, comprising a filling tube which is drivable and rotatable about its longitudinal axis and on to which can be pulled a case which can be filled by the filling tube, and a case brake which is arranged at the open end of the filling tube in a holding frame and which has a brake ring which is mounted rotatably coaxially with respect to the axis of rotation of the filling tube by means of a mounting means and a bearing,
wherein the open end of the filling tube is so designed as to co-operate with the brake ring and the case in such a way that the brake ring is drivable by means of the filling tube in frictional and/or positively locking relationship and a torque can be transmitted to the case.

2. A filling apparatus as set forth in claim 1 wherein the brake ring is freely rotatably mounted and is drivable exclusively by means of the drivable filling tube.

3. A filling apparatus as set forth in claim 1 wherein the filling tube has at least one flat face on its outer peripheral surface from its open end.

4. A filling apparatus as set forth in claim 1 wherein there is provided at least one roughened face, starting from the open end of the filling tube.

5. A filling apparatus as set forth in claim 1 wherein the filling tube starting from its open end has at least one elongate recess extending on its outer peripheral surface.

6. A filling apparatus as set forth in claim 5 wherein the recess is of a substantially V-shaped cross-section.

7. A filling apparatus as set forth in claim 5 wherein the recess (36) is of a curved cross-section.

8. A filling apparatus as set forth in claim 1 wherein the peripheral surface of the filling tube does not have any apertures.

9. A filling apparatus as set forth in claim 1 wherein the bearing of the brake ring is in the form of a rolling bearing, in particular a ball bearing.

10. A filling apparatus as set forth in claim 1 wherein the brake ring has a through opening for the case to pass therethrough, which opening is of a round or polygonal cross-section and/or at its inner peripheral surface has one or more recesses of any cross-section.

11. A machine for filling casings, in particular sausage cases, comprising a filling tube which is drivable and rotatable about its longitudinal axis and on to which can be pulled a case which can be filled by the filling tube, and a case brake which is arranged at the open end of the filling tube in a holding frame and which has a brake ring which is mounted rotatably coaxially with respect to the axis of rotation of the filling tube by means of a mounting means and a bearing,
wherein the open end of the filling tube is so designed as to co-operate with the brake ring and the case in such a way that the brake ring is drivable by means of the filling tube in frictional and/or positively locking relationship and a torque can be transmitted to the case.

12. A method of filling casings, in particular sausage cases, in which a case is pulled on to a filling tube and filled by means of a pasty material, in particular sausage meat, flowing out of the filling tube, and is drawn off the filling tube by the pressure of the material,
and in which a twist-off location is produced for portioning the case by rotation of the filling tube, wherein the case co-operates with a rotatable brake ring of a case brake,
wherein the filling tube is of such a configuration in the region of the open end of the filling tube that the brake ring is driven by way of the filling tube in frictional and/or positively locking relationship and a torque is transmitted to the case.
